(19) United States
(12) Patent Application Publication
(10) Pub. No.: US 2003/0093877 A1
(43) Pub. Date: May 22, 2003

(54) Hinge for furniture

(76) Inventor: Claus Hofer, Fussach (AT)

Correspondence Address: WENDEROTH, LIND & PONACK, L.L.P., 2033 K STREET N. W., SUITE 800, WASHINGTON, DC, 20006-1021, US

(21) Appl. No.: 10/298,067

(22) Filed: Nov. 18, 2002

(30) Foreign Application Priority Data
Nov. 19, 2001 (AT) GM 889/2001

(51) Int. Cl. E05D 7/04

(52) U.S. Cl. 16/235

(57) ABSTRACT

A hinge for articulating a door to a frame of a piece of furniture includes a base plate mounted on the frame. The base plate bears a hinge arm to which a hinge boss is articulated by a hinge pin. An intermediate member is positioned between the hinge arm and the base plate. The base plate, the intermediate member and the hinge arm are connected by a pin. The intermediate member is tiltable with respect to the base plate by means of an adjustment screw and the hinge arm is linearly moveable on the intermediate member in the direction of the depth of the piece of furniture.

### BACKGROUND OF THE INVENTION

The invention relates to a hinge having a hinge boss to be mounted on a door and a hinge arm which may be secured to a frame of an article of furniture. The hinge arm is mounted on a frame by means of a base plate that is fixed on the frame by at least one fixing screw or dowel. An intermediate member is positioned between the hinge arm and the base plate.

In modern furniture constructions so called door frames are in increasingly wide spread use, such frames being the stable part which bears the hinges for a door, the actual side walls of the carcass of the item of furniture being made of thinner material. This gives the advantage that either the total costs of the item of furniture can be reduced, since the side walls maybe extremely thin, or materials of higher quality which are consequently more attractive can be selected for the side walls without the furniture being more expensive then conventionally manufactured furniture.

Such a hinge is known from U.S. Pat. No. 5,930,866. This hinge is provided with an eccentric by which the position of the hinge arm with respect to the base plate can be adjusted.

### SUMMARY OF THE INVENTION

The object of the invention is to improve such a hinge making it easier to mount of the frame and to make an easier adjustment of the hinge arm and therefore of the door with respect to the frame possible.

The object according to the invention is achieved by the fact that the base plate, the intermediate member and the hinge arm are connected by a pin, whereby said intermediate part is tiltable around said pin with respect to said base plate by means of an adjustment screw and said hinge arm is slideable on said intermediate member in a direction transverse to said pin.

When mounting the hinge to the frame of an article of furniture the base plate, the intermediate part and the hinge arm are an assembly. They are held to the frame and fastened by the fixing screw. It is not necessary that the base plate is first screwed to the frame and that the intermediate part and the hinge arm are later mounted on the base plate.

In an embodiment of the invention the pin protrudes though circular holes in the base plate and the intermediate member and through slots in the hinge arm.

According to a further embodiment of the invention a good hold of the hinge arm on the intermediate member is achieved by the fact that the hinge arm and the intermediate member both have U-profile the hinge arm being mounted on the intermediate member and in that the side webs of the hinge arm are provided with inwardly directed projections which are slideable on the side webs of the intermediate member.

To provide an easier adjustment of the position of the hinge arm in the direction of the depth of the piece of furniture an eccentric is mounted on the intermediate member, the eccentric having a cam which is situated in an elongated hole of the hinge arm.

### BRIEF DESCRIPTION OF THE DRAWINGS

An exemplary embodiment of the invention is described in detail below with reference to the enclosed drawings wherein:

FIG. 1 is a perspective view of a hinge according to the invention;

FIG. 2 is a perspective view of a hinge according to the invention in the mounted position, sections of a frame and of a door being shown;

FIG. 3 is a section of a hinge according to the invention taken orthogonally to the hinge axis; and

FIG. 4 is an exploded perspective view of the parts of the hinge.

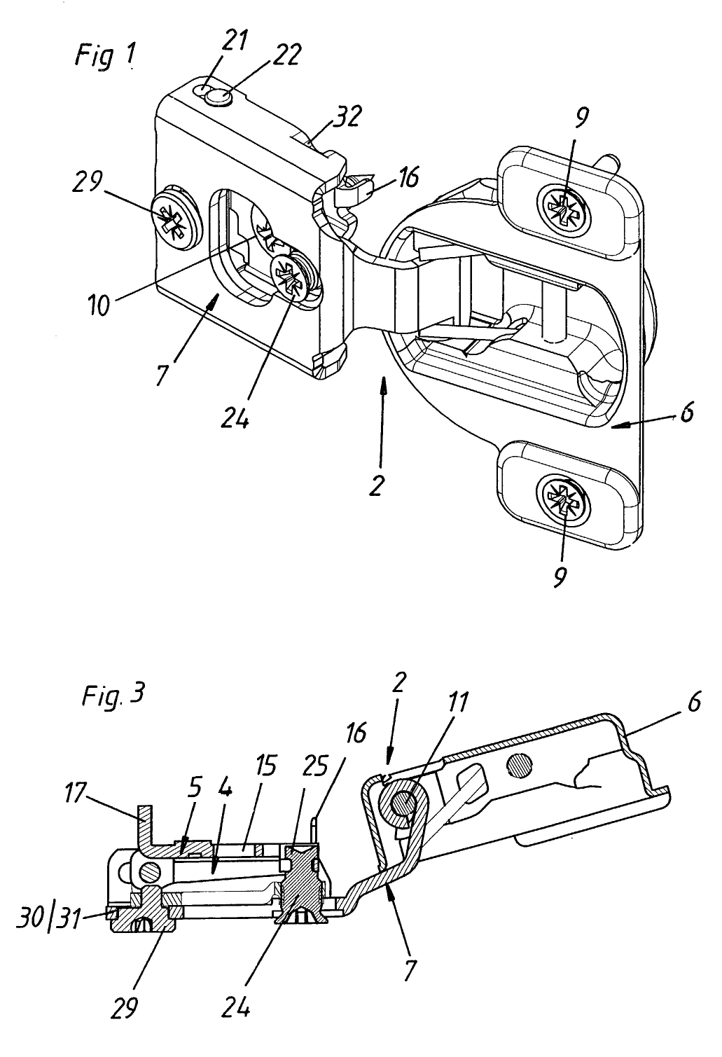

### DETAILLED DESCRIPTION OF THE INVENTION

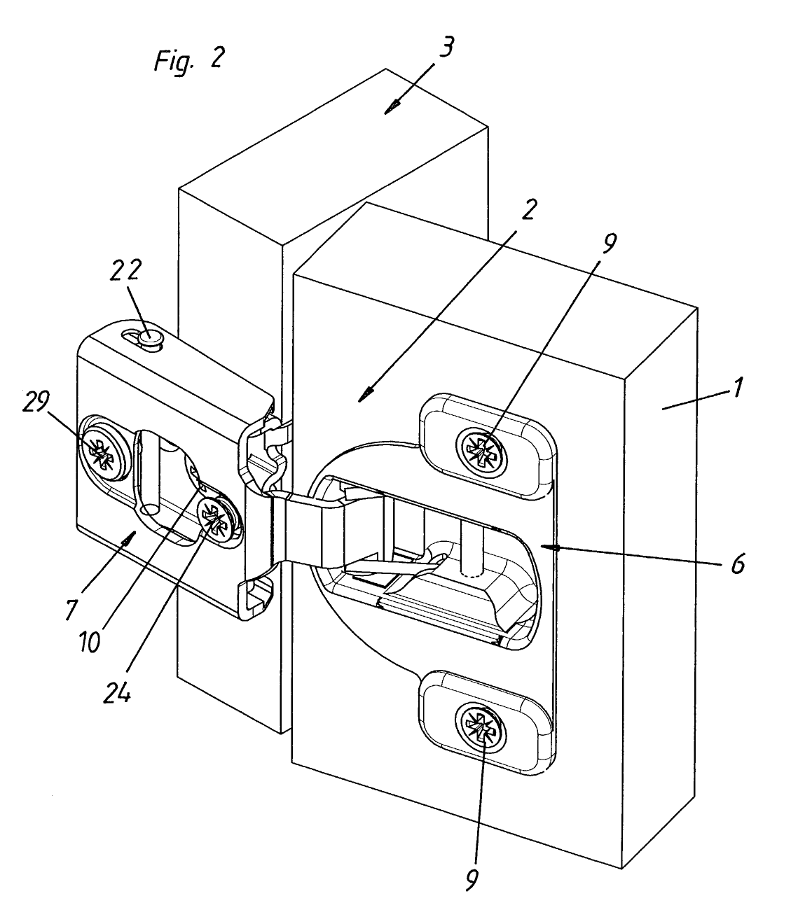

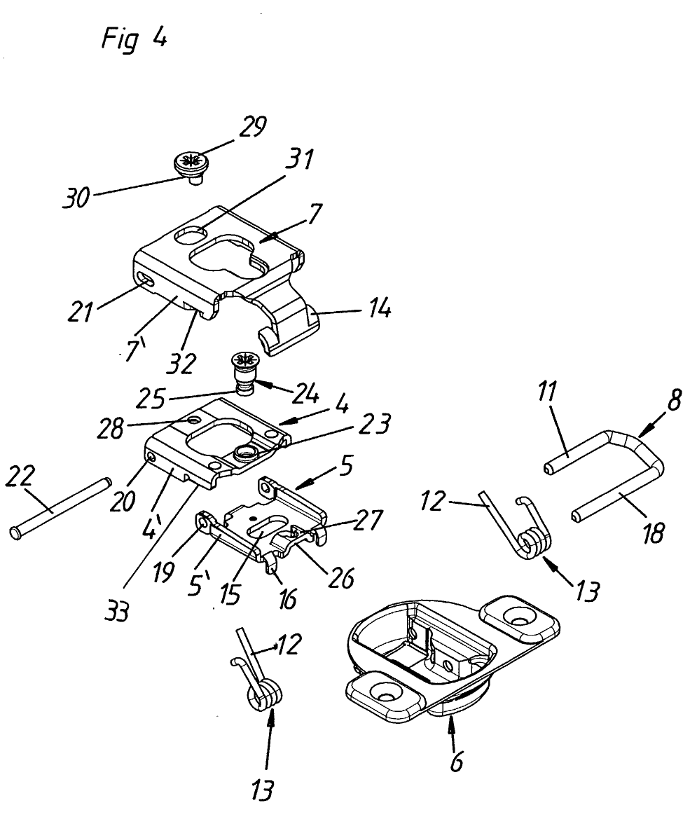

In FIG. 2 a door 1 is shown in an open position. The hinge 2 connects the door 1 to a frame 3 of a piece of furniture, e.g. a cabinet.

The hinge 2 includes a base plate 5, an intermediate member 4, a hinge arm 7 and a hinge boss 6 which is mounted on the door 1. The hinge boss 6 is hinged to the hinge arm 7 by hinge pin 11. The hinge pin 11 is part of bracket 8 in U-form.

The hinge boss 6 is set into a drilled hole in the door 1 and screwed onto the door 1 by means of screws 9.

Situated at the bottom of the hinge boss 6 is a retaining mechanism in which springs 13 of a closing mechanism are mounted. Legs 12 of springs 13 press on cam members 14 which are provided at the free end of the hinge arm 7. By means of the springs 13 with the legs 12 the hinge boss 6 is held in its closed position or, if the angle between the door 1 and closing plane is very small, is pulled into the closed position.

The base plate 5 is mounted directly on the frame 3 of the piece of furniture and is secured to the frame 3 by means of a fixing screw 10 which projects through an elongated hole 15 in the base plate 5. The base plate 5 has, at the side facing the door 1, 2 two bearing webs 16 which in the fitted position rest against the front of the frame 1. At the rear side of the frame 3 the base plate 5 is provided with a flap 17 which rests against the back of frame 3.

Over the length of the elongated hole 15 the position of the hinge can be adjusted on the piece of furniture in a vertical direction.

The base plate 5 as well as the intermediate member 4 and the hinge arm 7 have U-profile. The side webs 5′ of the base plate 5 are directed towards the intermediate member 4. The side webs 4′ of the intermediate member 4 and the side webs 7′ of the hinge arm 7 are directed towards the base plate 5. The side webs 5′ of the base plate 5 are provided with circular holes 19 which can be drilled holes or punched holes. The side webs 4′ of the intermediate member 4 are provided with circular holes 20 which also can be drilled holes or punched holes. The side webs 7′ of the hinge arm 7 are provided with slots 21. The intermediate member 4 and the hinge arm 7 are mounted on the base plate 5 by means of a pin 22 which protrudes through the circular holes 19, 20 and the slots 21.

The intermediate part 4 is provided with a female screw thread 23 in which an adjustment screw 24 is mounted. The adjustment screw 24 is provided with a screw head 25 which is anchored in a bridge 26 of the base plate 5. The bridge 26 which is punched out of the base plate 5 is provided with an open slot 27 in which the adjustment screw 24 is held. An eccentric 29 is mounted in the rear hole 28 of the intermediate member 4. The cam 30 of the eccentric 29 is positioned within an elongated hole 31 of the hinge arm 7.

Turning the adjustment screw 24 causes the hinge arm 7 and the intermediate member 4 to be tilted around the pin 22. Thereby at this placement of the hinge axle 11 in the direction of the door overlay, i.e. in a direction parallel to the door in the closed position is achieved.

By turning the eccentric 29 the hinge arm 7 is displaced on the intermediate member 4 in the direction of the depth of the piece of furniture. The hinge arm 7 can be moved over the length of the slots 21.

Height adjustment of the door 1 is achieved by loosening the fixing screw 10 and moving the hole hinge over the length of the elongated hole 15. When the hinge 2 is in its correct position the fastening screw 10 is tightened.

The side webs 7′ of the hinge arm 7 are provided with inwardly directed projections 32 which are punched out of the side webs 7′. The projections 32 which are positioned underneath the side webs 4′ of the intermediate member 4 together with the pin 22 provide the guiding means for linear movement of the hinge arm 7.

The side webs 4′ of the intermediate member 4 are provided with L-shaped cut outs 33. The projections 32 are situated within these cut outs 33.

1. A hinge for articulating a door to a frame of an article of furniture to enable movement of the door between open and closed positions thereof with respect to the frame, said hinge comprising:
a hinge boss to the mounted on the door;
a base plate to be mounted on the frame by at least one fixing screw;
an intermediate member and a hinge arm being mounted on the base plate, the hinge arm having an end hinged to said hinge boss;
the base plate, the intermediate member and the hinge arm being connected by a pin, whereby said intermediate part is tiltable around said pin with respect to said base plate by means of an adjustment screw and said hinge arm is slideable on said intermediate member in a direction transverse to said pin.

2. A hinge as claimed in claim 1, wherein said pin protrudes through circular holes in the base plate and the intermediate member and through slots in the hinge arm.

3. A hinge as claimed in claim 2, wherein the hinge arm and the intermediate member both have U-profile and are mounted on the base plate by means of said pin which protrudes through side webs of said U-profiles.

4. A hinge as claimed in claim 1, wherein said adjustment screw is mounted in a female thread in said intermediate part and is provided with a screw head which is anchored in said base plate.

5. A hinge as claimed in claim 4, wherein said adjustment screw protrudes through a slot which is provided in a bridge of said base plate on the side of said intermediate member.

6. A hinge as claimed in claim 1, wherein an eccentric is mounted in said intermediate member, the eccentric having a cam which is situated in an elongated hole of the hinge arm.

7. A hinge as claimed in claim 3, wherein the side webs of the hinge arm are provided with inwardly directed projections which are slideable on rims of the side webs of the intermediate member.

8. A hinge as claimed in claim 7, wherein the side webs of the intermediate member are provided with cut outs, the projections of the hinge arm being situated within said cut outs.
